(19) United States
(12) Patent Application Publication
(10) Pub. No.: US 2013/0167734 A1
(43) Pub. Date: Jul. 4, 2013

(54) Coating Article For Preventing Metal Leaching Into Edible Materials And Method Of The Same

(71) Applicant: Avoca Holdings LLC, Fort Worth, TX (US)

(72) Inventors: Garold Marvin La Rue, III, Fort Worth, TX (US); Robert William Melvin, Portland, OR (US)

(73) Assignee: AVOCA HOLDINGS LLC, Fort Worth, TX (US)

(21) Appl. No.: 13/729,654

(22) Filed: Dec. 28, 2012

Related U.S. Application Data
(60) Provisional application No. 61/581,567, filed on Dec. 29, 2011.

(51) Int. Cl. A47J 31/06

(52) U.S. Cl. CPC A47J 31/0689
USPC 99/323; 427/244

(57) ABSTRACT

The present disclosure provides for an article of manufacture composed of a metallic structure for use in the preparation of an edible material and includes a coating of titanium nitride to prevent metal leaching from the article into the edible material when the article and edible material interact, thereby decreasing the metallic taste of the edible material and enhancing the delectability of the edible material upon consumption.

### CROSS-REFERENCE TO RELATED APPLICATIONS

Applicant claims priority to U.S. Provisional Patent Application No. 61/581,567, filed Dec. 29, 2011, the disclosure of which is incorporated by reference herein in its entirety.

### DESCRIPTION OF THE DRAWINGS

FIG. 1 is a perspective view of an espresso machine having a portafilter device attached thereto;

FIG. 2 is a perspective view of a portafilter device;

FIG. 3 is a perspective view of espresso passing through a portafilter basket and into a cup;

FIG. 4 is a perspective view of the bottom portion of a portafilter basket wherein the portafilter basket is coated in titanium nitride comprising an embodiment of the present invention;

FIG. 5 is a sectional view of the portafilter basket of FIG. 4;

FIG. 6 is a sectional view of the portafilter basket of FIG. 4; and

FIG. 7 is an enlarged portion of the sectional view of the portafilter basket of FIG. 4.

### BACKGROUND OF THE INVENTION

Throughout the course of time, mankind has endeavored to perfect the quality, flavor and vigor of edible materials such as food and drink. Edible materials not only can provide sustenance, enabling the sustainability and continuity of life, but also can provide immense pleasure and enjoyment during consumption. As such, it is not uncommon for a person to consume a particular type of food or drink primarily for its taste and/or flavor. Food and drink connoisseurs make it their life's ambition to locate, consume and rate the best tasting foods and/or drinks based on an assortment of criteria such as taste, texture, flavor, odor, after-taste, form, potency, quality, etc. Furthermore, many businesses exist to exploit the high demand for good tasting food and/or beverages. Therefore for centuries, mankind's never-ending pursuit for higher quality and more flavorful edible materials has continued unabated.

Advancements in technology have aided societies' ability to prepare delectable food and drink. New and innovative machines, articles of manufacture and processes have provided the means for transforming non-edible materials into edible materials and the means for extracting edible materials from non-edible materials. Undoubtedly, coffee aficionados, for example, are keenly aware of the manner in which coffee is extracted from coffee beans. Without advancements in technology, society likely would be unable to partake and enjoy certain edible materials or experience refinements in the taste and/or quality of already existing edible materials.

While improvements in technology have increased the variety and vastness of edible materials suitable for mankind, notable negative side effects have resulted. One such negative effect is the increase of the acidity level in an edible material during its creation and/or processing. This increase in the acidity level occurs when the edible material is exposed to, contacts and/or interacts with metallic material(s). By contacting, exposure to and/or interacting with metallic material, the edible material's acidity level increases, thereby heightening the edible material's metallic taste. A heightened metallic taste is often undesirable. This process is known as metal leaching or metal transfer.

During ingestion, a heightened metallic taste can reduce considerably the delectability of an edible material. It also leaves an unpleasant and palpable after-taste. Moreover, it can have potential negative health affects as well. Thus, to improve the delectability, flavor, quality, after-taste, pleasantness and health benefits associated with an edible material that contacts, interacts with and/or is exposed to metallic material before ingestion, metal leaching/transfer from the metallic material into the edible material must be reduced or completely prevented. In so doing, the edible material's true taste can be manifestly and fully enjoyed during consumption.

Edible material comes is all sizes, shapes, forms and states. Generally, it can be defined broadly as food such as, but not limited to, solid-type material and drink, such as, but not limited to, liquid-type material, each type having suitability for ingestion and consumption by the human body. Examples of liquid include beverages such as, but not limited to, coffee, tea, water, soft drinks, espresso, etc. While occurring in connection with solid-type edible material, metal leaching/transfer occurs more notably in connection with liquid-type edible material such as beverages. This may be due to a liquid's greater surface-area contact with metallic material, thereby increasing the metal leaching/transfer, or it may be due to a person's ability to more easily perceive a difference in the metallic taste of liquids versus solids. Therefore, beverages are impacted more negatively by metal leaching/transfer than food. As such, metal leaching/transfer, is a major concern for those creating, preparing, processing, selling or consuming beverages.

During the preparation and/or processing of beverages such as coffee, tea, mate and herbal infusions, metallic filters and/or screens are often utilized. While they perform various important functions in the preparation and processing of beverages, unfortunately metallic filters and screens contribute greatly to the process of metal leaching/transfer. This occurs as portions of the beverage contact, interact and pass through the screen/filter. Oftentimes, the liquid passes through the metallic screen/filter and then moves directly into a cup or container for immediate human consumption as in the case of an espresso machine. As such, the beverage's taste is negatively impacted, having an associated slight bitter, acidic taste which is usually perceptible to espresso aficionados.

What is needed is an article and method that prevents metal leaching/transfer which occurs when edible material contacts, interacts and/or is exposed to metallic material. More specifically, what is needed is a filter for use in preparing and/or processing beverages which is comprised of a coating of titanium nitride that covers the filter's metallic surface to prevent metal leaching/transfer that occurs when portions of the beverage contact, are exposed to and/or interact with the filter's metallic surface, thereby decreasing the beverages metallic taste and enhancing the beverage's delectability and quality.

A filter for use in the preparation and/or processing of beverages comprised of a titanium nitride coating, having embodiments disclosed herein, is a novel invention that meets the needs described in the above paragraphs while also providing many substantial advantages such as ease of applicability, cost effectiveness, durability and the ability to prevent metal leaching/transfer into the beverage. Each embodiment of the present invention provides the ability to coat an article of manufacture, which has a metallic exterior, with titanium nitride, so that metal leaching/transfer does not occur upon the article's contact with food or drink.

While the present invention relates to all articles of manufacture in connection with the preparation or processing of food and drink, an embodiment of the invention, which is explored in the disclosure herein, comprises an article such as, but not limited to, a filter or screen which is coated in titanium nitride and which is utilized in the preparation and processing of beverages such as, but not limited to, coffee, tea, espresso, mate and herbal infusions such as in espresso machines, french presses and tea infusers.

Metallic filters and screens are used to prepare brewed infused and extracted drinks worldwide. Metallic articles utilized in connection with drinks are ubiquitous, especially articles such as filter and screens. Thus, metallic residue used in beverage preparation can leach into the beverage being brewed, particularly when beverage acidity is present. Subsequently, beverage taste is negatively affected.

To solve the taste degradation caused by metallic leaching/transfer, a ceramic coating of titanium nitride can be applied to the filter, coating the exterior thereof. The coating prevents metal contact with the beverage, thereby remedying the problem.

Utilizing titanium nitride as a coating agent has many benefits that heretofore have been unknown until the conception of the present invention. First, a coating of titanium nitride to an article can be applied in a very thin layer. Therefore, coating an article such as a filter, which has small apertures or perforations therein to allow the passing of liquid therethrough, will not affect the filter's primary function, because the thin coating of titanium nitride will not substantially reduce the diameter of each of the filter's apertures or perforations. Thus, a coating of titanium nitride can be applied to already-constructed filters without impeding the filter's functionality.

Second, the process of coating an article with titanium nitride produces extreme durability for both the article as well as the article's exterior; the coating does not easily chip away or quickly deteriorate. Once applied to a filter, the coating will remain thereon for a substantial amount of time. Furthermore, in other fields of endeavor, coating with titanium nitride coating is utilized for its wear-resistant capabilities, durability and lubricity in connection with cutting tools and sliding mechanical components. However, until now, titanium nitride's capabilities as a ceramic coating to prevent metallic transfer have been unknown and undiscovered. Embodiments of the present invention represent a new use for titanium nitride coating.

Third, coating an article with titanium nitride yields non-toxic and non-reactive results. In other fields of endeavor, titanium nitride has been utilized in surgical implants such has hip joints and pacemaker enclosures. Furthermore, other applications of its use include doorknobs and plumbing fixtures. Therefore, it is safe for use.

Fourth, titanium nitride forms a strong, hard coating barrier. Because of its strength, it can be applied in a thin manner as described above. The thin coating coupled with its toughness allows it to offer durability while not materially altering the dimensions of the underlying article. The underlying article such as a filter can often be a standard, commodity product. Thus, titanium nitride coating will not inhibit an article's functionality, thereby allowing an article to be used for its intended purposes without it having to be redesigned and/or reengineered. Therefore, an article can be used in its current form with the application of the ceramic coating of titanium nitride.

Fifth, a coating of titanium nitride allows an article such as a filter or basket to exhibit ceramic-like properties all the while having a metallic-based structure. This allows the article to maintain its strength and durability that comes with metallic-based structures while exhibiting other beneficial qualities such as the lack of metal leaching that occur with the use of ceramic-based structures. The best of both worlds is achieved.

Ceramic titanium nitride coating in connection with the preparation of food and drink offer many advantages that otherwise would not be possible using current techniques, articles and methodologies. Properly applied, a ceramic coating of titanium nitride will not chip or delaminate from an article but will allow the article's durability and shock-resistant attributes to remain intact and operable.

### DETAILED DESCRIPTION

While the present invention encompasses numerous embodiments involving differing articles of manufacture and machines, each having a metallic exterior which is coated with titanium nitride to prevent metallic leaching/transfer when an edible material contacts or interacts with the article or machine, thereby enhancing the taste of the edible material, one particular embodiment disclosed herein involves the making of espresso using a standard espresso machine and a standard portafilter basket wherein the portafilter basket is coated with titanium nitride to reduce metallic leaching/transfer, thereby enhancing the taste of the espresso.

Espresso is a concentrated beverage brewed by forcing a small amount of nearly boiling water under pressure through finely ground coffee beans. During the brewing process, the beverage is directed into a basket which collects unwanted solid material but allows the liquid portions to pass therethrough into a cup or container for consumption. Often, the basket is metallic in nature and therefore metal leaching occurs during this process. An embodiment of the present invention includes coating the basket with titanium nitride to prevent metal leaching/transfer into the beverage, thereby enhancing the espresso's taste.

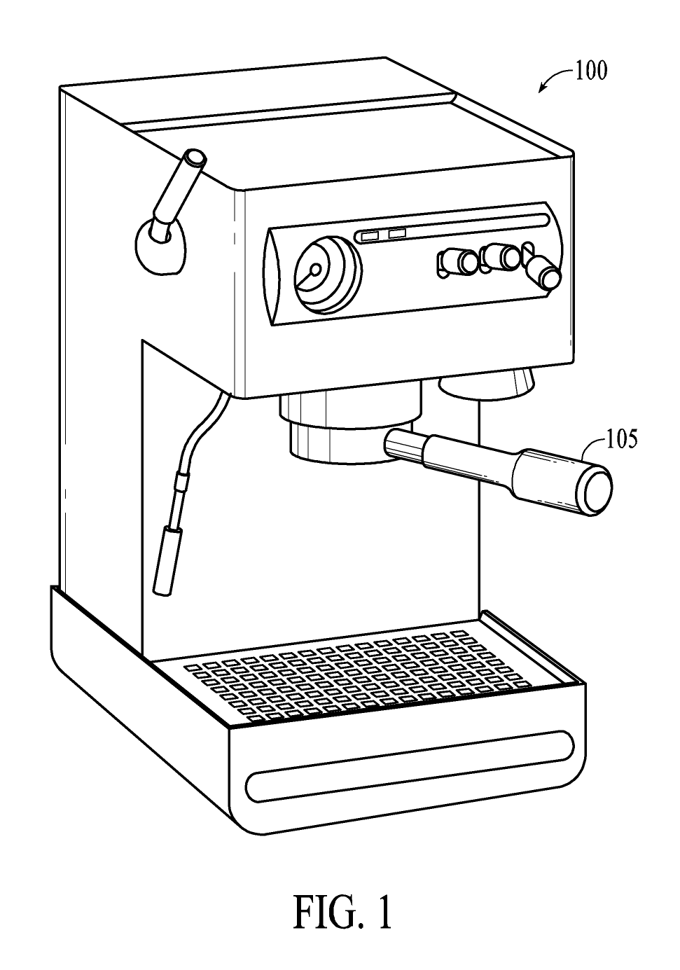

Turning now to FIG. 1, an illustration is shown that depicts a standard espresso machine 100 utilized for brewing espresso. Attached to the espresso machine 100 is a portafilter device 105. The portafilter device 105 can be detached and/or reattached to the espresso machine 100 repeatedly at the pleasure of the operator.

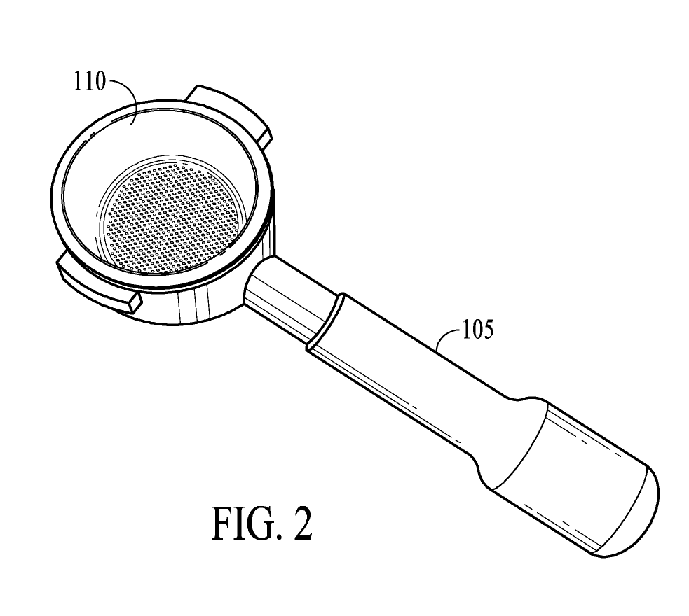

FIG. 2 depicts a portafilter device 105 shown separate and independent from the espresso machine 100. At its distal end, the portafilter device 105 engages a portafilter basket 110. The portafilter basket 110 is a filter screen which holds coffee grounds and allows liquid from the espresso machine 100 to pass therethrough. Typically, the structural composition of the portafilter basket 110 is constructed of brass or a similar type of metallic-like structure. At its proximal end, the portafilter device 105 engages a plastic, rubber or wooden handle.

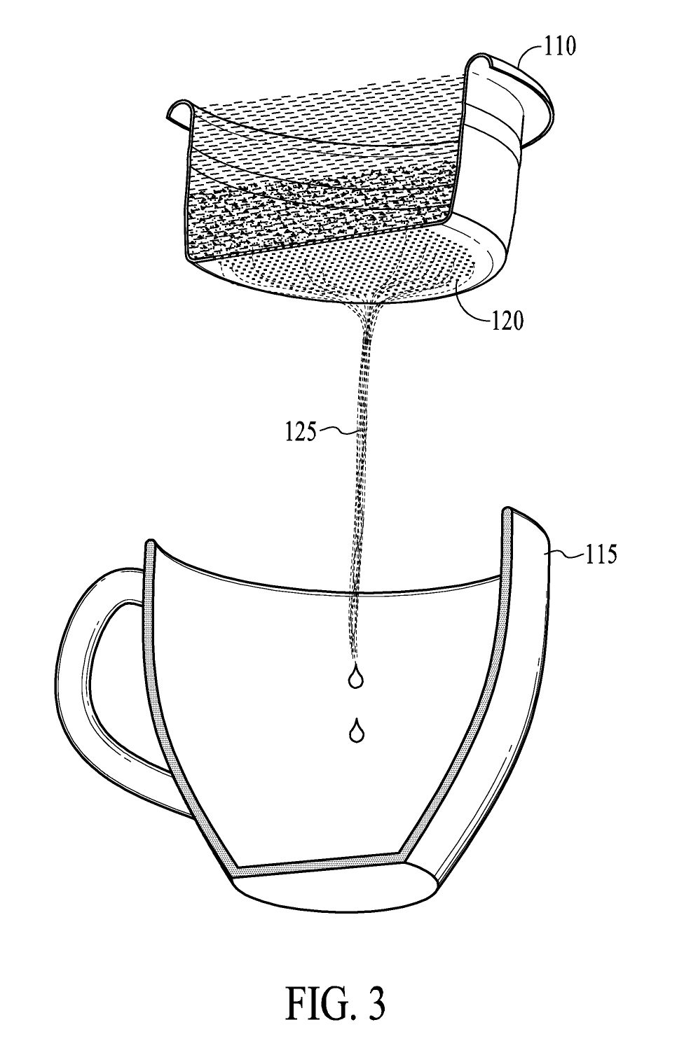

FIG. 3 illustrates the process by which metal leaching/transfer occurs in connection with the making of espresso. As hot liquid such as water is forced into a portafilter basket 110 containing coffee grounds, the hot liquid not only interacts with the coffee grounds but contacts and interacts with the metallic material of the portafilter basket 110 whereupon metal leaching/transfer occurs into the liquid. Then, liquid 125 is forced through a series of perforations 120 located at the bottom of the portafilter basket 110 whereupon the liquid, now espresso 125, falls into a cup 115 and is ready for human consumption.

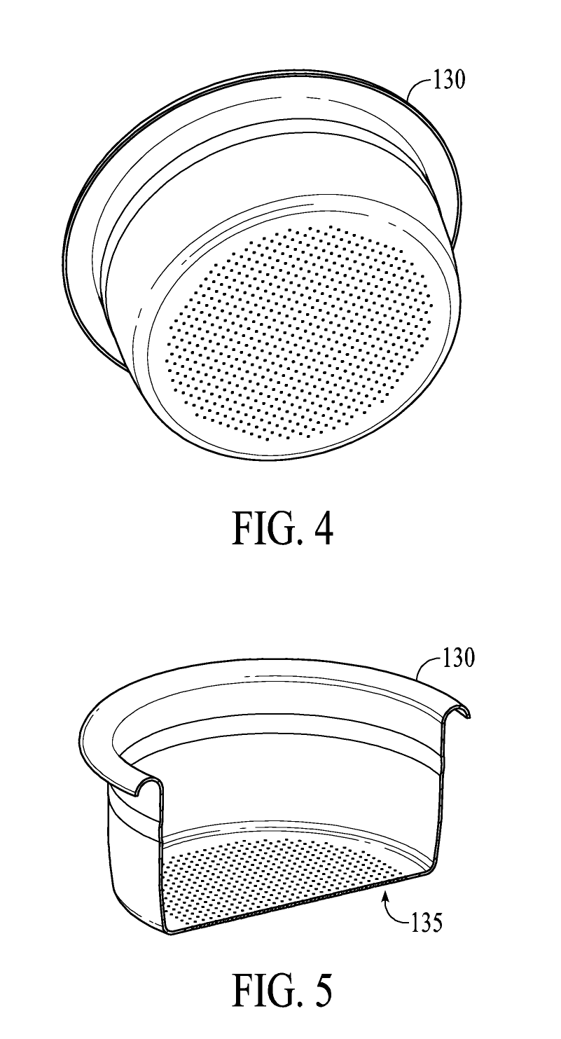

FIG. 4 depicts a portafilter basket 130 coated in titanium nitride. As shown, the portafilter basket 130 is nearly identical in appearance to a non-coated portafilter basket. FIG. 5 depicts the cross-section of the portafilter basket 130 coated in titanium nitride. It is evident that the coating does not interfere with the utility or functionality of the portafilter basket 130 because the coating does not obstruct the series of perforations 135 located at the bottom of the portafilter basket 130. As mentioned above, the lack of obstructionism in the series of perforations 135 is due to the ability to apply the coating in a thin layer. Titanium nitride coating can be applied having a thickness of between three (3) to five (5) microns.

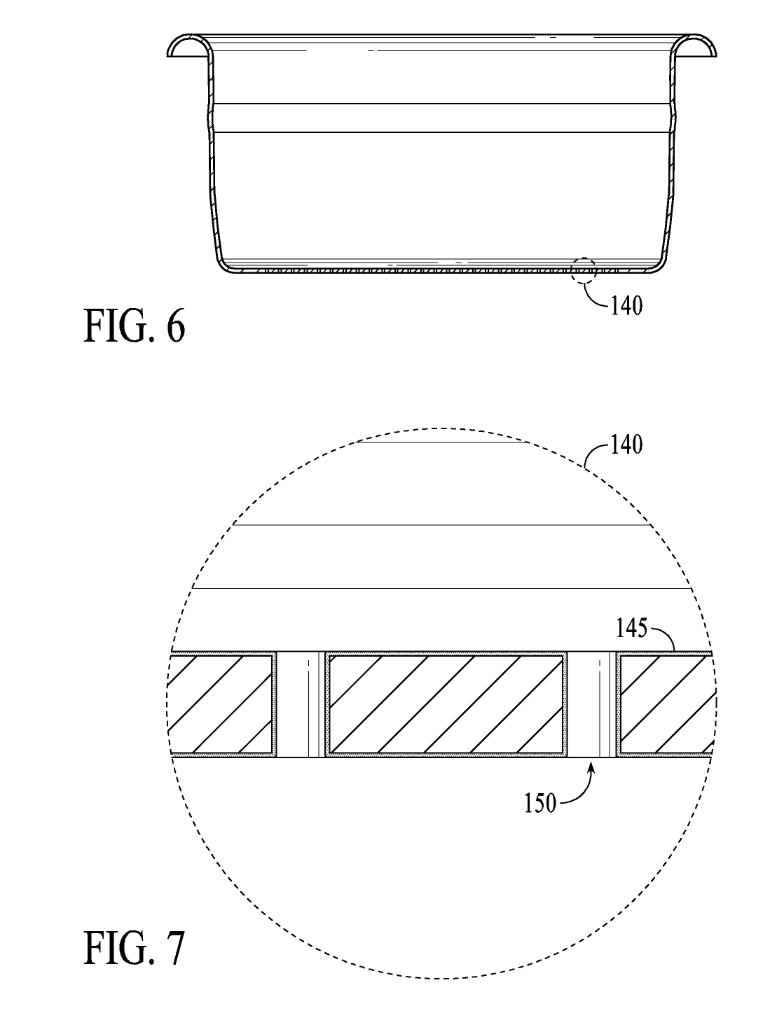

FIGS. 6 and 7 depict a sectional view of a portafilter basket 130 coated in titanium nitride, the depictions, however focus specifically on the series of perforations 140 at the bottom of the portafilter basket 130. FIG. 7 depicts an enlarged portion of the perforations 140 depicted in FIG. 6. As can be seen in FIG. 7, the coating of titanium nitride 145 is thinly applied to the entire surface of the portafilter basket 130, covering the metallic structure. Because only a thin coating is needed, the perforation 150 in the portafilter basket 130 remains unobstructed, thus allowing the portafilter basket 130 to perform its function in the espresso machine unimpeded all the while preventing metal leaching/transfer from seeping into the espresso. No metal leaching/transfer into an espresso produces a better tasting and higher quality drink.

In this disclosure, it should be noted that metal leaching, metallic leaching and metal transfer refer to the same process. Therefore, the terms as used herein are interchangeable. Also, it should be noted that terms filter, screen and basket, including their association with espresso machines, as used herein are interchangeable terms for the purposes of the present invention.

Moreover, as disclosed herein, the embodiments of the present invention apply to filters, screens and baskets, regardless of type, function or properties, portafilters, regardless of type, function or properties and espresso machines, regardless of type, function or properties.

Although many embodiments of the present invention have been illustrated in the accompanying Drawings and described in the foregoing Detailed Description, it should be understood that the present invention is not limited to the embodiments disclosed, but is capable of numerous rearrangements, modifications, and substitutions of parts and elements without departing from the spirit of the invention.

What is claimed is:

1. An article of manufacture composed of a metallic structure for use in the preparation of an edible material, the article comprising a coating of titanium nitride to prevent metal leaching from the article into the edible material when the article and edible material interact, thereby decreasing the metallic taste of the edible material and enhancing the delectability of the edible material upon consumption.

2. The article of claim 1 wherein the thickness of the coating of titanium nitride applied thereon is between 3 to 5 microns.

3. The article of claim 1 wherein the article is a portafilter basket used in the preparation of espresso.

4. The article of claim 2 wherein the article is a portafilter basket used in the preparation of espresso.

5. A portafilter basket for use in an espresso machine to make espresso, the portafilter basket comprising a coating of titanium nitride to inhibit metal leaching into espresso caused by the portafilter basket and to allow the portafilter basket to exhibit ceramic-like properties, thereby decreasing the metallic taste of espresso while enhancing the delectability of espresso upon consumption.

6. The portafilter basket of claim 5 wherein the thickness of the coating of titanium nitride applied thereon is between 3 to 5 microns.

7. A method of inhibiting metal leaching that occurs in the preparation of espresso to enhance the delectability of espresso which comprises applying a coat of titanium nitride to a portafilter basket.

8. The method of claim 8 wherein the coating of titanium nitride, when applied, has a thickness of between 3 to 5 microns.
